(19) United States
(12) Patent Application Publication
(10) Pub. No.: US 2008/0235810 A1
(43) Pub. Date: Sep. 25, 2008

(54) Method of Authorizing Access to Content

(75) Inventors: Antonius Adriaan Maria Staring, Eindhoven (NL); Menno Anne Treffers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,244

(22) PCT Filed: Jan. 12, 2005
(86) PCT No.: PCT/IB05/50131

§ 371 Date: Jul. 18, 2006

(30) Foreign Application Priority Data
Jan. 22, 2004 (EP) 04100215.5

(51) Int. Cl. G06F 1/00

(52) U.S. Cl. 726/29

(57) ABSTRACT

A method of and source device (410) for authorizing access to content (425) by a sink device (400) in accordance with usage rights, the content being stored on a storage medium (420) controlled by the source device. The revocation status of the sink device is verified using the most recently issued revocation information that is available if the usage rights need to be modified as part of the authorization of access to the content, and using revocation information associated with the content stored on the storage medium, preferably the revocation information stored on the storage medium, otherwise. The revocation information on the storage medium, or only the part relating to the sink device, is optionally updated to the most recently issued revocation information if the usage rights need to be modified. Preferably this is done only if the result of the verification is that the sink device has been revoked.

The invention relates to a method of authorizing access to content by a sink device in accordance with usage rights, the content being stored on a storage medium controlled by a source device. The invention further relates to a source device arranged to perform the method.

Digital media have become popular carriers for various types of data information. Computer software and audio information, for instance; are widely available on optical compact disks (CDs) and recently also DVD has gained in distribution share. The CD and the DVD utilize a common standard for the digital recording of data, software, images, and audio. Additional media, such as recordable discs, solid-state memory, and the like, are making considerable gains in the software and data distribution market.

The substantially superior quality of the digital format as compared to the analog format renders the former substantially more prone to unauthorized copying and pirating, further a digital format is both easier and faster to copy. Copying of a digital data stream, whether compressed, uncompressed, encrypted or non-encrypted, typically does not lead to any appreciable loss of quality in the data. Digital copying thus is essentially unlimited in terms of multi-generation copying. Analog data with its signal to noise ratio loss with every sequential copy, on the other hand, is naturally limited in terms of multi-generation and mass copying.

The advent of the recent popularity in the digital format has also brought about a slew of copy protection and digital rights management (DRM) systems and methods. These systems and methods use technologies such as encryption, watermarking and right descriptions (e.g. rules for accessing and copying data).

One way of protecting content in the form of digital data is to ensure that content will only be transferred between devices if
the receiving device has been authenticated as being a compliant device, and
the user of the content has the right to transfer (move and/or copy) that content to another device.
   If transfer of content is allowed, this will typically be performed in an encrypted way to make sure that the content cannot be captured illegally in a useful format from the transport channel, such as a bus between a CD-ROM drive and a personal computer (host).

Technology to perform device authentication and encrypted content transfer is available and is called a secure authenticated channel (SAC). In many cases, a SAC is set up using an Authentication and Key Exchange (AKE) protocol that is based on public key cryptography. Standards such as International Standard ISO/IEC 11770-3 and ISO/IEC 9796-2, and public key algorithms such as RSA and hash algorithms like SHA-1 are often used.

To set up a SAC, each device typically contains a unique encryption key that is used in a challenge/response protocol with another device to calculate a temporary, mutually shared key. The two devices subsequently use this shared key to protect the exchanged content and usage rights information.

Over the life-time of the DRM or content protection system, the unique encryption key of one or more devices may be compromised (e.g. it becomes public knowledge, or it is misused otherwise). In order to repair such damage, the SAC establishment protocol typically contains means to revoke the compromised keys. For this purpose, the licensor of the system maintains a revocation list of all compromised devices. In the initial steps of the SAC establishment protocol, each device must ensure that the other device is not on the revocation list.

Revocation lists can be set up in two ways. In the “black list” approach, devices that have been revoked are listed, and a device thus is revoked if it appears on the black list. The “white list” approach is the reverse. In this approach device thus is revoked if it does not appear on the white list. In this document, “being revoked” or “being on the revocation list” means “appearing on the black list” or “not appearing on the white list” depending on which approach is used.

Ways of efficiently maintaining and distributing revocation lists are disclosed in international patent application WO 03/107588 (attorney docket PHNL020543) and in international patent application WO 03/107589 (attorney docket PHNL020544). International patent application WO 01/42886 (attorney docket PHA 23871) discloses an efficient way of combining a contact list and a revocation list.

In order to maintain an adequate level of security, a device should not communicate with a compromised device. Otherwise, a user could exploit the compromised device to release content from the content protection system. To achieve this level of security, each device should store an instance of the most recently issued revocation list in internal memory, and check whether any device with which communication is desired does not appear on this revocation list.

A problem with this approach is that a whole content collection may become unplayable after a device stores a more recently issued instance of the revocation list. To explain this, consider the following scenario in which a player (e.g. a DVD-Video player) is connected to a rendering device (e.g. a PC that is running appropriate software). Now assume in this scenario that the rendering device has been compromised, and therefore has been added to the revocation list. Then, after the player has received a copy of the revocation list that revokes the compromised rendering device, a user can no longer use the rendering device to play any piece of content from his/her collection. Since distribution of the revocation list occurs beyond control of the user, this is very unfriendly to the user.

To avoid this problem, in an alternative approach devices always use the instance of the revocation list that is pre-recorded on the storage media (such a optical discs), instead of an internally stored instance. This means that if a particular combination of media, player and rendering device is authorized to play the protected content once, that combination is always authorized to play the protected content. An example of a system that uses this approach is the Content Protection for Recordable Media (CPRM) system.

However, a problem with this alternative approach is that a user can exploit “old” media, which contain an outdated instance of the revocation list, to release content from the content protection system (e.g. using a software tool that has contains one or more of the compromised uniqe encryption keys, which are not revoked on those media).

It is an object of the invention to provide a method according to the preamble, which strikes a balance between the security requirements and the user requirements. From a security perspective, the amount of compromised content (i.e. content that has been released from the content protection system) should be reduced or preferably minimized. From a user point of view, the system should behave predictably, i.e. no sudden surprises like having one's device(s) revoked without doing anything wrong.

This object is achieved according to the invention in a method comprising verifying the revocation status of the sink device using the most recently issued revocation information that is available if the usage rights need to be modified as part of the authorization of access to the content, and using revocation information associated with the content stored on the storage medium otherwise.

Using the most recently issued revocation information that is available ensures that the security level is kept as high as possible whenever the usage rights information is updated. Using revocation information associated with the content stored on the storage medium provides user-friendly operation, in the sense that playback is always safe as no unexpected revocation will occur.

In an embodiment revocation information that was applicable when the content was stored on the storage medium is used if the usage rights do not need to be modified. In particular, revocation information stored on the storage medium can be used in this case.

In a further embodiment the method comprises updating the revocation information recorded on the storage medium to the most recently issued revocation information if the usage rights need to be modified. Preferably only the part of the revocation information relating to the sink device could be updated. Optionally the updating is performed only if the result of the verification is that the sink device has been revoked. As a result, the revocation information recorded on the storage medium when the content was recorded on the storage medium is overwritten. From that moment on, the hacked device will always be detected as revoked, even if later used for accesses for which the usage rights do not need to be modified.

In a further embodiment the method comprises verifying the revocation status of the sink device using revocation information associated with the content stored on the storage medium only if the usage rights do not need to be modified and the usage rights grant unlimited permission to make copies of the content, and the most recently issued revocation information otherwise. This reduces the adverse effects of supplying the content to a revoked device which makes a copy of the content. If unlimited permission to make copies is granted, then the copies made by the revoked device are lawfully made.

These and other aspects of the invention will be apparent from and elucidated with reference to the illustrative embodiments shown in the drawings, in which:

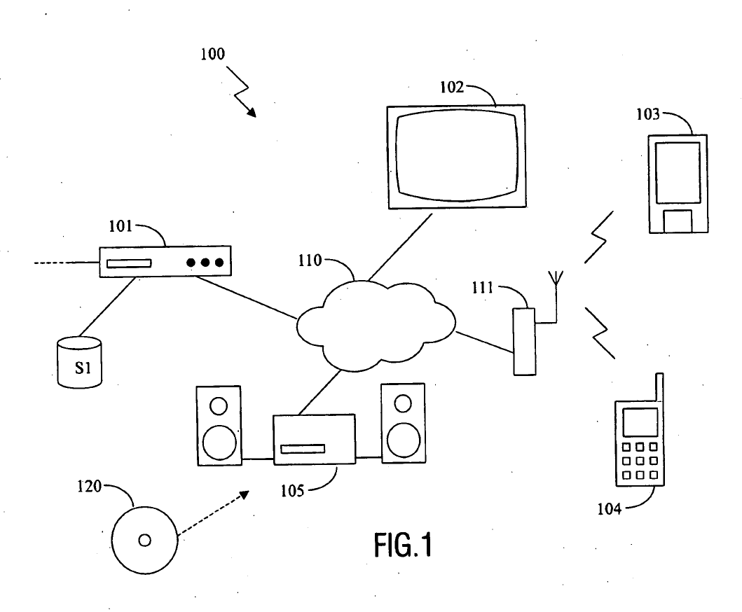

FIG. 1 schematically shows a system comprising devices interconnected via a network;

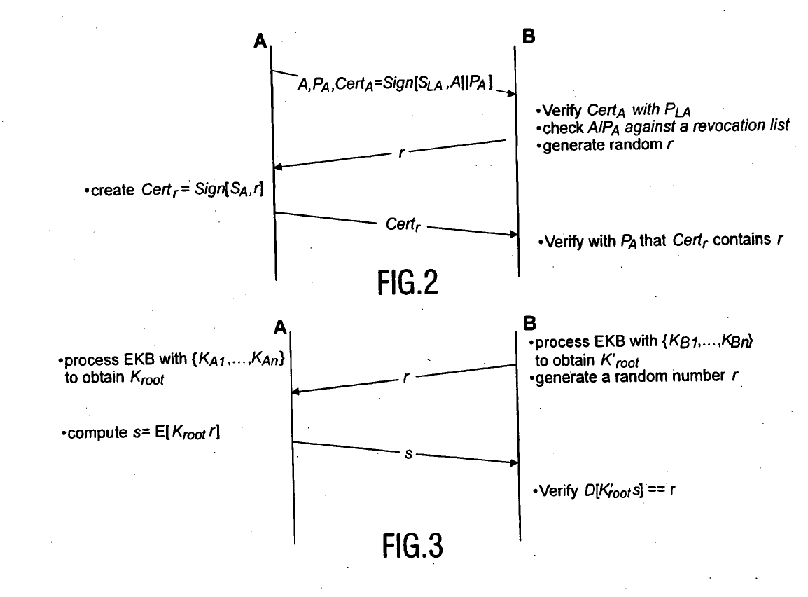

FIG. 2 schematically illustrates a Challenge/Response Public Key protocol;

FIG. 3 schematically illustrates a Broadcast based protocol; and

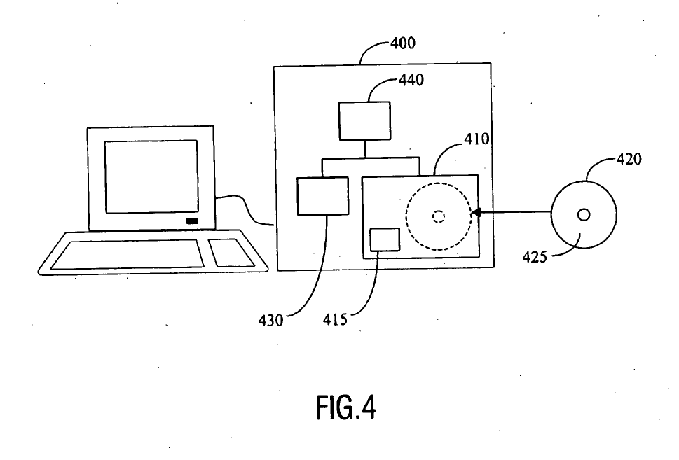

FIG. 4 schematically shows an exemplary embodiment of the invention in which a source device authenticates a sink device.

Throughout the figures, same reference numerals indicate similar or corresponding features. Some of the features indicated in the drawings are typically implemented in software, and as such represent software entities, such as software modules or objects.

### System Architecture

FIG. 1 schematically shows a system 100 comprising devices 101-105 interconnected via a network 110. In this embodiment, the system 100 is an in-home network. A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set top box (STB), is usually the central device, providing central control over the others.

Content, which typically comprises things like music, songs, movies, TV programs, pictures, books and the likes, but which also includes interactive services, is received through a residential gateway or set top box 101. Content could also enter the home via other sources, such as storage media as discs or using portable devices. The source could be a connection to a broadband cable network, an Internet connection, a satellite downlink and so on. The content can then be transferred over the network 110 to a sink for rendering. A sink can be, for instance, the television display 102, the portable display device 103, the mobile phone 104 and/or the audio playback device 105.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 101, or any other device in the system 100, may comprise a storage medium S1 such as a suitably large hard disk, allowing the recording and later playback of received content. The storage medium S1 could be a Personal Digital Recorder (PDR) of some kind, for example a DVD+RW recorder, to which the set top box 101 is connected. Content can also enter the system 100 stored on a carrier 120 such as a Compact Disc (CD) or Digital Versatile Disc (DVD).

The portable display device 103 and the mobile phone 104 are connected wirelessly to the network 110 using a base station 111, for example using Bluetooth or IEEE 802.11b. The other devices are connected using a conventional wired connection. To allow the devices 101-105 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http:/www.upnp.org).

It is important to ensure that the devices 101-105 in the home network do not make unauthorized copies of the content. To do this, a security framework, typically referred to as a Digital Rights Management (DRM) system is necessary. In one such framework, the home network is divided conceptually in a conditional access (CA) domain and a copy protection (CP) domain. Typically, the sink is located in the CP domain. This ensures that when content is provided to the sink, no unauthorized copies of the content can be made because of the copy protection scheme in place in the CP domain. Devices in the CP domain may comprise a storage medium to make temporary copies, but such copies may not be exported from the CP domain. This framework is described in European patent application 01204668.6 (attorney docket PHNL010880) by the same applicant as the present application.

Regardless of the specific approach chosen, all devices in the in-home network that implement the security framework do so in accordance with the implementation requirements. Using this framework, these devices can authenticate each other and distribute content securely. Access to the content is managed by the security system. This prevents the unprotected content from leaking “in the clear” to unauthorized devices and data originating from untrusted devices from entering the system.

Technology to perform device authentication and encrypted content transfer is available and is called a secure authenticated channel (SAC). In many cases, a SAC is set up using an Authentication and Key Exchange (AKE) protocol that is based on public key cryptography. Standards such as International Standard ISO/IEC 11770-3 and ISO/IEC 9796-2, and public key algorithms such as RSA and hash algorithms like SHA-1 are often used.

In general there are three types of such authentication protocols which are not based on a universal secret:
1. challenge/response authentication, such as protocols based on the establishment of a secure authenticated channel (SAC), which are only supported by bi-directional communication channels,
2. Zero Knowledge Protocols, such as those by Fiat-Shamir, Guillou-Quisquater (see U.S. Pat. No. 5,140,634, attorney docket PHQ 087030), and Schnorr, are also only supported on bi-directional channels, and
3. broadcast encryption, which works on both uni-directional and bi-directional channels.

In a broadcast encryption protocol, authentication is usually closely linked with transfer of the content decryption key. For this purpose, each participant has a unique set of cryptographic keys. Here, these keys are referred to as secret keys. Individual secret keys may be in included in the sets of many participants. The publisher creates a message that contains the content decryption key. This message is encrypted using the secret keys in such a way that only a subset of all participants can decrypt the content key. Participants that can decrypt the content key are implicitly authenticated. Participants that are not in the subset, and thus cannot decrypt the content key, are revoked.

E.g. for the uni-directional channel from the publisher to the player, one can use a broadcast encryption technology that is based on a hierarchical tree of cryptographic keys. The broadcast message is called the EKB. The decryption key contained in the EKB is called the Root Key. For more information, see
D. M. Wallner, E. J. Harder, and R. C. Agee, “Key Management for Multicast: Issues and Architectures,” Request For Comments 2627, June 1999.
C. K. Wong, M. Gouda, and S. Lam, “Secure Group Communications Using Key Graphs,” Proceedings SIG-COMM 1998, ACM Press, New York, pp. 68-79.

### Notation

The following notation will be adhered to in this document:
Pₓ [symbol] the public key belonging to X
Sₓ [symbol] the private key belonging to X
C=E[K,M] [symbol] ciphertext C is the result of encrypting message M with key K
M′=D[K,C] [symbol] plaintext A′ is the result of decrypting C with key K.
Cert_{A}=Sign[S_{B},A] [symbol] Certificate Cert_{A} is the result of signing message A with private key S_{B}

### Challenge/Response Based Public Key Protocol

In a Challenge/Response Public Key protocol, a user A (which can be a device) desires to authenticate him/herself to user B (which can also be a device). To that end A has received from a Licensing Authority (LA) the following:
a public-private key pair {P_{A}, S_{A}} (Of course the LA also supplies other information such as a modulus which defines the finite field in which calculations are done. For brevity we omit reference to this other information)
a certificate Cert_{A}=Sign[S_{LA}, A∥P_{A}], where S_{LA} is the private key of the LA All users (A and B) receive the public key of the licensing authority P_{LA}

The protocol is outlined in FIG. 2. It works generally as follows:
1. A identifies himself to B by providing his identifier, here the serial number A, his public key P_{A}, and his certificate from the LA.
2. B verifies the public key and identity of A from the certificate, using the public key of the LA, P_{LA}. If required, B checks that A and P_{A} aren't revoked: i.e. they appear on a whitelist or do not appear on a black-list. If true, B proceeds by generating a random number r, and sends it to A.
3. A responds by signing (encrypting) r with his private key S_{A} into a certificate Certᵣ and returns the result to B.
4. Using A's public key P_{A}, B verifies that the content of the certificate is identical to the number r he sent in step 2. If correct, A has proven that he has the secret key belonging to the public key P_{A}, i.e. he is A.

Step 1 can be postponed until step 3, so that only 2 passes are needed. To achieve mutual authentication, the protocol can be repeated with the entities performing the steps reversed. The steps can also be interchanged, e.g. first step 1 with A providing his identifier to B, then step 1 with B providing his identifier to A, and similarly for the other steps.

A variant of this protocol is one where B sends the random number r encrypted with A's public key. A then demonstrates knowledge of his secret key, by decrypting the received number r and returning it to B.

After authentication, a common key needs to be established, which can be done in a variety of ways. For example, A chooses a secret random number s and encrypts it with P_{B}, and forwards it to B. B can decrypt it with S_{B} to s, and both parties can use s as a common key.

It is clear that at the very least the protocol requires one private key operation from both parties, and perhaps 2 or more depending on the exact bus-key establishment protocol. Public key cryptography requires substantial computation power. For a host such as a personal computer this usually is not a problem. However, for a peripheral device like a CD-ROM drive, a handheld computer or a mobile phone, resources are at a premium. A solution to this problem is presented in European patent application serial number 03101764.3 (attorney docket PHNL030753).

### Broadcast-Based Protocols

In a Broadcast based protocol, a user A again desires to authenticate him/herself to another user B. To that end the LA supplies user A with
a set of device keys {K_{A1}, . . . , K_{An}}, which set is unique to A.
   and User B with
another set of device keys {K_{B1}, . . . , K_{Bn}}, which set is unique to B.

The LA distributes to both users a so called keyblock, known under various guises as “MKB” (CPRM/CPPM), “EKB” (Sapphire), “RKB” (BD-RE CPS), “KMB” (xCP). From this point on, we will refer to it as EKB. The EKB is e.g. distributed on optical media, or via the internet. It is constructed in such a way that the devices that have not been revoked can extract a root-key from this key-block, which will be the same for all these devices. Revoked devices will only obtain nonsense from using their (revoked) device keys.

For an illustration of the protocol, refer to FIG. 3. It works as follows.
1. Both A and B compute the secret Kᵣₒₒₜ encoded in the EKB with their respective device keys. If they are not revoked, they will both obtain Kᵣₒₒₜ. B generates a random number r, and sends it to A.
2. A encrypts the received number with the secret extracted from the EKB and returns the result s to B
3. B decrypts s and verifies that the result is r.

To achieve mutual authentication, the protocol can be repeated with the entities performing the steps reversed. The steps can also be interchanged, e.g. first step 1 with A providing his identifier to B, then step 1 with B providing his identifier to A, and similarly for the other steps.

Note that B does not verify that A is who he claims, but only that A knows Kᵣₒₒₜ, i.e. A has not been revoked by the LA.

Broadcast Encryption based authentication is very cheap and fast because it requires only cost efficient symmetric cryptography. However, in the case where B is the PC-host software, the protocol is vulnerable to an insidious attack. Note that, contrary to the previous section, in order to check the integrity of A, the PC-software also needs to know Kᵣₒₒₜ. Now software is often hacked, and this means Kᵣₒₒₜ could be extracted from the software and published on a web-site, allowing a hacker to set up to authenticate successfully. Such software is hard to revoke, because no device keys are published in the attack.

After a few devices have been hacked and their device keys retrieved, hackers can start making their own (newer) EKBs thus turning once revoked devices back into non-revoked devices. To counter this, EKBs are often signed with the private key of the LA, so that tampering can be immediately detected.

### Revocation Management

In order to maintain an adequate level of security, a device should not communicate with a compromised device. In the initial steps of the SAC establishment protocol, each device must ensure that the other device is not on the revocation list. To this end, the devices have access to revocation information in the form of this list or a derivative thereof. For example, a device with limited storage capacity may store only part of the list.

The revocation information may be obtained in a variety of ways. It can be recorded on a storage medium, so that it can be read by devices into which the medium is inserted. This medium could also hold content, or be dedicated to the storage of revocation information. The revocation information can be distributed via a network connection using a virus-like distribution mechanism. A server can be set up to which devices can send queries regarding the revocation status of a particular device. The server will determine whether the particular device has been revoked and send an appropriate response.

The invention will now be explained by way of an exemplary embodiment in which a source device authenticates a sink device. This embodiment is illustrated in FIG. 4. In FIG. 4, the source device is a DVD reading/writing (DVD+RW) drive 410 installed in the sink device which is a personal computer 400. The source device 410 controls access to content 425 such as a movie recorded on a DVD disc 420. An application 430 running on the personal computer 400 wants to access this content 425. To this end it must communicate with the source device 410, typically via the operating system 440 which interfaces between the various components in the personal computer 400. As the content is protected, the source device 410 will only grant the requested access if it can successfully authenticate the sink device 400. Granting access may involve supplying the content over a bus in the personal computer 400 to the application 430 in protected or in unprotected form.

As part of the authorization of access to the content 425, the usage rights information may need to be updated. For example, a counter indicating how many times the content may be accessed may need to be decreased. A one-time playback right may need to be deleted or have its status set to ‘invalid’ or ‘used’. A so-called ticket could also be used. See U.S. Pat. No. 6,601,046 (attorney docket PHA 23636) for more information on ticket-based access.

This updating of the usage rights may be done by the source device 410 or by the sink device 400.

In this authentication process, the source device 410 verifies the revocation status of the sink device 400. To this end it comprises a revocation status checking module 415, typically embodied as a software program.

Verifying the revocation status involves the use of revocation information. There are multiple versions of the revocation information available. One version may be stored on the storage medium 420 together with the content 425. Another version may be available on a different storage medium. Another version may have been transmitted to the source device 410 over a network. These versions likely differ from one another. The source device 410 can determine which is the most recent one by comparing the dates of issue of the respective versions.

If the usage rights need to be modified, the source device 410 uses the most recently issued revocation information that is available. This ensures that the security level is kept as high as possible whenever the usage rights information is updated. A malicious hacker now cannot use a revoked device to e.g. make a recording of content with a one-time playback right. Because the source device 410 uses the most recent revocation information, the authentication with the hacked device will fail as the device has been revoked.

In this case, optionally the revocation information recorded on the storage medium 420 is updated to the most recently issued revocation information. As a result, the revocation information recorded on the storage medium 420 when the content 425 was recorded on the storage medium 420 is overwritten. From that moment on, the hacked device will always be detected as revoked, even if later used for accesses for which the usage rights do not need to be modified.

This embodiment may also result in other devices than the sink device 400 being revoked. To avoid this, it may be desirable to update only the revocation information relating to the sink device 400. This way, only the sink device 400 is “locked out” of the content 420 on the storage medium 425.

If the usage rights do not need to be modified, the source device 410 uses revocation information associated with the content stored on the storage medium. This provides user-friendly operation, in the sense that playback is always safe as no unexpected revocation will occur.

Preferably the version of the revocation information stored on the storage medium 420 is used. This revocation information may date from the moment on which the content 425 was recorded on the storage medium 420, or may have been updated as explained above.

Alternatively, revocation information from another source that was applicable when the content was stored on the storage medium 425 is used. For instance, after determining the date on which the data was stored, the source device 410 can select a version with a date of issue that is at most equal to that date. The revocation information may also have some other identifier that allows the source device 410 to determine whether it was applicable when the content was stored on the storage medium 425.

By using “older” revocation information, there is a risk that the content 420 is supplied to a compromised—and hence revoked—device which makes a copy without usage restrictions. If the usage rights associated with the content 420 only grant permission for playback for example, it must be avoided that the sink device makes a copy. In this situation, the usage rights do not need to be modified and hence the “old” revocation information would be used, i.e. a version less recent than the most recent version available. To solve this particular problem, the use of the “old” revocation information should be restricted to only those situations in which the usage rights do not need to be modified and grant unlimited permission to make copies of the content 420.

It should be noted that the above-mentioned embodiments illustrate rather than limit the invention, and that those skilled in the art will be able to design many alternative embodiments without departing from the scope of the appended claims.

For instance, the devices do not have to be personal computers and DVD reading/writing drives, or even host devices and peripheral devices. Any device that is required to authenticate another device and/or to authenticate itself to that other device can benefit from the present invention. The content can be distributed on any medium or via any transport channel. For example, the content can be distributed on flash media or over a USB cable.

The device transmitting or receiving the content over the SAC may perform checks to see whether transmitting or receiving is permitted. For example, the content may have a watermark that indicates no copies may be made. In such a case transmission or reception should be blocked even if a SAC was successfully set up.

The devices could be part of a so-called authorized domain in which more liberal copying rules may apply. In authorized domains also SACs are commonly used to establish secure content transfer between the members of the domain. See for example international patent application WO 03/047204 (attorney docket PHNL010880) and international patent application WO 03/098931 (attorney docket PHNL020455).

To allow (prospective) owners of such devices to determine the revocation status of their equipment, the method according to international patent application WO 03/019438 (attorney docket PHNL010605) can be used.

The invention is preferably implemented using software running on the respective devices and arranged to execute the protocol according to the invention. To this end the devices may comprise a processor and a memory to store the software. Secure hardware for e.g. storing cryptographic keys is preferably used. A smart card can be provided with such a processor and a memory. The smart card can then be inserted into a device to enable the device to use the invention. Of course the invention can also be implemented using special circuitry, or a combination of dedicated circuitry and software.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the system claim enumerating several means, several of these means can be embodied by one and the same item of hardware. The mere fact that certain measures are recited in mutually different dependent claims does not indicate that a combination of these measures cannot be used to advantage.

1. A method of authorizing access to content by a sink device in accordance with usage rights, the content being stored on a storage medium controlled by a source device, the method comprising
verifying the revocation status of the sink device using
the most recently issued revocation information that is available if the usage rights need to be modified as part of the authorization of access to the content,
revocation information associated with the content stored on the storage medium otherwise.

2. The method of claim 1, in which revocation information that was applicable when the content was stored on the storage medium is used if the usage rights do not need to be modified.

3. The method of claim 1 or 2, in which revocation information stored on the storage medium is used if the usage rights do not need to be modified.

4. The method of claim 3, comprising updating the revocation information recorded on the storage medium to the most recently issued revocation information if the usage rights need to be modified.

5. The method of claim 4, comprising only updating the part of the revocation information relating to the sink device.

6. The method of claim 4 or 5, in which the updating is performed only if the result of the verification is that the sink device has been revoked.

7. The method of claim 1, comprising verifying the revocation status of the sink device using revocation information associated with the content stored on the storage medium only if the usage rights do not need to be modified and the usage rights grant unlimited permission to make copies of the content, and the most recently issued revocation information otherwise.

8. A source device (410) arranged for authorizing access to content (425) by a sink device (400) in accordance with usage rights, the content being stored on a storage medium (420) controlled by the source device, the source device comprising
revocation status checking means (415) for verifying the revocation status of the sink device using
the most recently issued revocation information that is available if the usage rights need to be modified as part of the authorization of access to the content,
revocation information associated with the content stored on the storage medium otherwise.

9. The source device of claim 8, in which the revocation status checking means are arranged to use revocation information that was applicable when the content was stored on the storage medium if the usage rights do not need to be modified.

10. The source device of claim 8, in which the revocation status checking means are arranged to verify the revocation status of the sink device using revocation information associated with the content stored on the storage medium only if the usage rights do not need to be modified and the usage rights grant unlimited permission to make copies of the content, and the most recently issued revocation information otherwise.

11. A computer program product arranged to cause a processor to execute the method of claim 1.
